(19) United States
(12) Patent Application Publication
(10) Pub. No.: US 2020/0225777 A1
(43) Pub. Date: Jul. 16, 2020

(54) Mouse with adjustable height

(71) Applicant: Beijing Miiiw Technology Co., Ltd., Beijing (CN)

(72) Inventors: Zhenhao Chen, Beijing (CN); Xuebing Cao, Beijing (CN); Xiangwen Wu, Beijing (CN)

(73) Assignee: Beijing Miiiw Technology Co., Ltd.

(21) Appl. No.: 16/795,592

(22) Filed: Feb. 20, 2020

(30) Foreign Application Priority Data
Dec. 10, 2019 (CN) 201911255235.4

(51) Int. Cl. G06F 3/0354

(52) U.S. Cl. CPC G06F 3/03543; G06F 2203/0333

(57) ABSTRACT

A mouse with an adjustable height includes an outer casing, a bottom casing, a middle casing, a switch, a jacking, a swing arm, a DC (direct current) motor and a base, wherein: the swing arm having an arch shape is assembled with the DC motor, the DC motor is fixed on the base; the jacking is fixed on the middle casing and is fitted with the swing arm in a sliding manner; the bottom casing is located at a bottom of the outer casing, the middle casing is connected with the outer casing; the base is located within the outer casing and is fixed on the bottom casing. When the switched is activated, the DC motor drives the swing arm to rotate counterclockwise, the swing arm drives the jacking to move upwardly for driving the middle housing to rotate counterclockwise, so that the height of the mouse is increased.

### CROSS REFERENCE OF RELATED APPLICATION

The present invention claims priority under 35 U.S.C. 119(a-d) to CN 201911255235.4, filed Dec. 10, 2019.

### BACKGROUND OF THE PRESENT INVENTION

### Field of Invention

The present invention relates to the field of mouse, and more particularly to a mouse with an adjustable height.

### Description of Related Arts

In order to meet the needs of mobile office, people need a lighter, thinner and more portable mouse, but a small mouse usually has insufficient fit with the palm support and poor comfort, so that a user feels tired after using the small mouse for a long time. In the prior art, the height of a thin and light mouse can be increased by folding a body of the mouse to improve the use comfort. At present, other portable mice on the market are folded by sliding a casing of the mouse to increase the length of the mouse, a main body of the mouse is not folded. However, such mice are usually smaller in size and have a flat palm radian, so that the user has a poor feel. There is also another way to increase the length of the mouse that a tail portion of the mouse is bent or rotated for form a palm radian, and a main body of the mouse is not folded. However, internal components of this mouse are mainly located on a head portion of the mouse. In order to make the mouse thinner, there is usually no wheel. Accordingly, the touch function is used instead of the wheel, and there is no middle button function of pressing downwardly. In this solution, after being folded, a side of the mouse is hollowed out, so that the finger grip is not comfortable enough.

### SUMMARY OF THE PRESENT INVENTION

An object of the present invention is to provide a mouse with an adjustable height, wherein: a body of the mouse is able to be raised with a switch so as to achieve a balance between thinness portability and comfortable feel.

To achieve the above object, the present invention provides a mouse with an adjustable height, which comprises: an outer casing, a bottom casing, a middle casing, a switch, a jacking, a swing arm, a DC (direct current) motor and a base, wherein:
the swing arm having an arch shape is assembled with the DC motor, the DC motor is fixed on the base;
the jacking is fixed on the middle casing and is fitted with the swing arm in a sliding manner;
the bottom casing is located at a bottom of the outer casing;
the base is located within the outer casing and is fixed on the bottom casing;
whereby, when the switched is activated, the DC motor drives the swing arm to rotate counterclockwise around a motor shaft of the DC motor, the swing arm drives the jacking to move upwardly for driving the middle housing to rotate counterclockwise, so that a height of the mouse is increased.

Preferably, when the mouse is in a closed state, a first end of the swing arm is in contact with the jacking; when the mouse is in an open state, a second end of the swing arm is in contact with the jacking.

Preferably, the motor shaft of the DC motor comprises a cross-shaped rib, the swing arm has a cross-shaped groove, the cross-shaped rib is fitted with the cross-shaped groove.

More preferably, a distance between the first end of the swing arm and the cross-shaped groove is smaller than the second end of the swing arm and the cross-shaped groove.

Compared with the prior art, the present invention has beneficial effects as follows.
(1) It is convenient to carry while taking into account the comfort of the palm part.
(2) When the outer casing of the mouse is lifted, the volume of the mouse is increased and the shape of the mouse retains intact, and meanwhile, the wheel and the side of the mouse have a better grip.
(3) The components can be arranged at the outer casing of the mouse, so that the mouse provided by the present invention has a sufficient space compared with other foldable mice, and has a wider range of hardware options, which is conductive to reducing product costs.

### BRIEF DESCRIPTION OF THE DRAWINGS

FIG. 1 is a structurally schematic view of a mouse according to a preferred embodiment of the present invention.

FIG. 2 is a structurally schematic view when the mouse is in an open state.

FIG. 3 is a structurally schematic view when the mouse is in a closed state.

FIG. 4 is another structurally schematic view when the mouse in the open state.

### DETAILED DESCRIPTION OF THE PREFERRED EMBODIMENT

To make objects, technical solutions, and advantages of the embodiments of the present invention clearer, the technical solutions in the embodiments of the present invention will be clearly and completely described with accompanying drawings as follows.

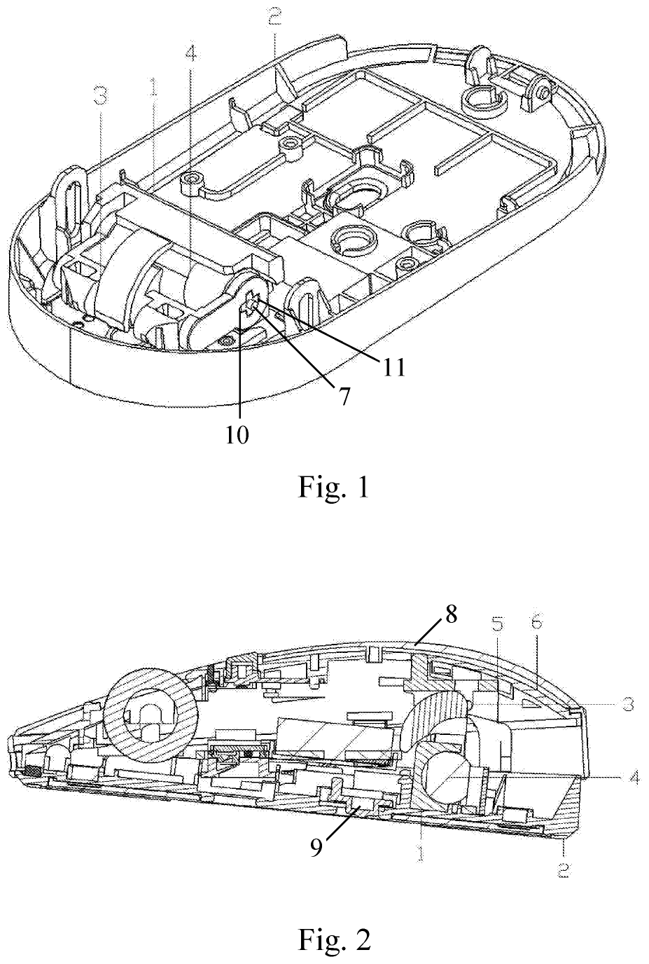

Referring to FIGS. 1 to 4, a mouse with an adjustable height according to a preferred embodiment of the present invention is illustrated, which comprises an outer casing 8, a bottom casing 2, a middle casing 6, a switch 9, a jacking 5, a swing arm 3, a DC (direct current) motor 4 and a base 1, wherein: the swing arm 3 having an arch shape is assembled with the DC motor 4, the DC motor 4 is fixed on the base 1; the jacking 5 made from a hard material is fixed on the middle casing 6 and is fitted with the swing arm 3 in a sliding manner, when the swing arm 3 applies an upward force to the jacking 5, the mouse is able to be gradually lifted to a target height; the bottom casing 2 is located at a bottom of the outer casing 8; the base 1 is located within the outer casing 8 and is fixed on the bottom casing 2; the switch 9 is a button and is located at a tail portion or a bottom portion of the mouse for controlling turn-on or off the mouse; whereby, when the switched is activated, the DC motor 4 drives the swing arm 3 to rotate counterclockwise around a motor shaft 7 of the DC motor 4, the swing arm 3 drives the jacking 5 to move upwardly for driving the middle housing 6 to rotate counterclockwise, so that a height of the mouse is increased.

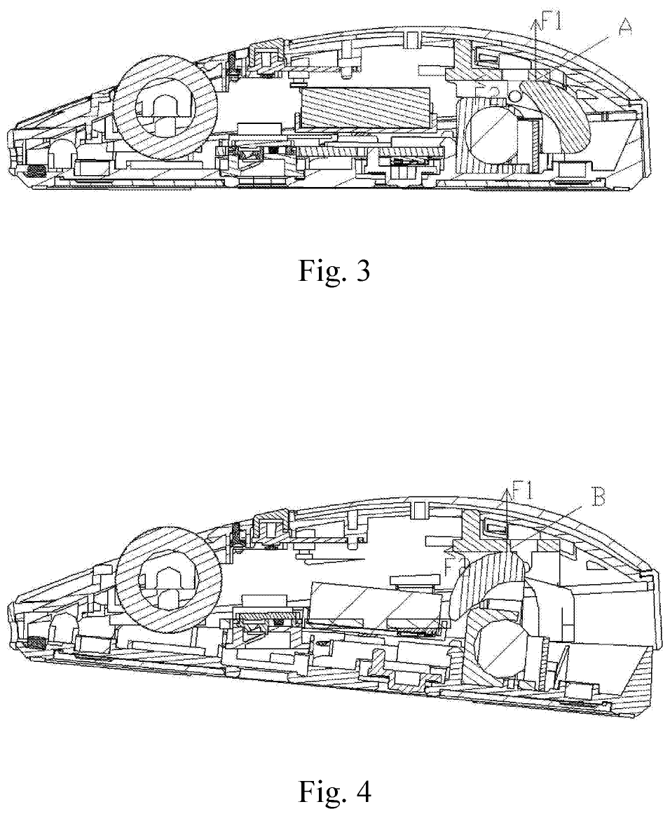

Preferably, when the mouse is in a closed state, a first end of the swing arm 3 is in contact with the jacking 5; when the mouse is in an open state, a second end of the swing arm 3 is in contact with the jacking 5. As shown in FIGS. 3-4, an arch-shaped surface of the swing arm 3 is in contact with a surface of the jacking 5; when the swing arm 3 rotates, the contact between a point A (the first end) on the arch-shaped surface of the swing arm 3 and the jacking 5 gradually transforms into the contact between a point B (the second end) on the arch-shaped surface of the swing arm 3 and the jacking 5. While the contact transforms from the point A to the point B, an upward force F1 (F1 is a vertically upward force, F2 is a horizontal force, F1 is perpendicular to F2) is produced, so that the jacking 5 is lifted for lifting the mouse, as shown in FIG. 4. When the swing arm 3 is in the position shown in FIG. 3, the mouse is closed.

Preferably, the motor shaft 7 of the DC motor 4 comprises a cross-shaped rib 10, the swing arm has a cross-shaped groove 11, the cross-shaped rib 10 is fitted with the cross-shaped groove 11. When the DC motor 4 works, the motor shaft 7 rotates to drive the swing arm 3 to rotate around the cross-shaped rib.

More preferably, a distance between the first end of the swing arm 3 and the cross-shaped groove 11 is smaller than the second end of the swing arm 3 and the cross-shaped groove 11. Since the distances between the first and second ends of the swing arm 3 and the cross-shaped rib 10 (that is, a rotational axis of the swing arm 3) are different, when the contact between the point A (the first end) on the arch-shaped surface of the swing arm 3 and the jacking 5 gradually transforms into the contact between the point B (the second end) on the arch-shaped surface of the swing arm 3 and the jacking 5, the vertically upward force F1 is produced.

For the mouse provided by the present invention, through the cooperation of the jacking 5, the swing arm 3, the DC motor 4, and the base 1, the user only needs to operate a switch to lift up the mouse body, thereby achieving the balance between lightness portability and comfortable feel.

It will be apparent to those skilled in the art that the present invention is not limited to the details of the above-mentioned exemplary embodiments, and that the present invention can be implemented in other specific forms without departing from the spirit or basic features of the present invention. Accordingly, the embodiments are to be regarded as exemplary and non-limiting in every respect, and the scope of the present invention is defined by the appended claims rather than the above description. Therefore, all changes that fall within the meaning and scope of equivalents of the claims are included in the present invention. Any reference signs in the claims should not be construed as limiting the claims involved.

What is claimed is:

1. A mouse with an adjustable height, which comprises: an outer casing, a bottom casing, a middle casing, a switch, a jacking, a swing arm, a DC (direct current) motor and a base, wherein:
the swing arm having an arch shape is assembled with the DC motor, the DC motor is fixed on the base;
the jacking is fixed on the middle casing and is fitted with the swing arm in a sliding manner;
the bottom casing is located at a bottom of the outer casing;
the base is located within the outer casing and is fixed on the bottom casing;
whereby, when the switched is activated, the DC motor drives the swing arm to rotate counterclockwise around a motor shaft of the DC motor, the swing arm drives the jacking to move upwardly for driving the middle housing to rotate counterclockwise, so that a height of the mouse is increased.

2. The mouse, as recited in claim 1, wherein: when the mouse is in a closed state, a first end of the swing arm is in contact with the jacking; when the mouse is in an open state, a second end of the swing arm is in contact with the jacking.

3. The mouse, as recited in claim 1, wherein: the motor shaft of the DC motor comprises a cross-shaped rib, the swing arm has a cross-shaped groove, the cross-shaped rib is fitted with the cross-shaped groove.

4. The mouse, as recited in claim 3, wherein: a distance between the first end of the swing arm and the cross-shaped groove is smaller than the second end of the swing arm and the cross-shaped groove.
